(19) United States
(12) Patent Application Publication
(10) Pub. No.: US 2020/0192958 A1
(43) Pub. Date: Jun. 18, 2020

(54) SYSTEM AND METHOD FOR QUANTIFYING PUBLIC DISPOSITION WITH RESPECT TO ELECTRONIC MEDIA CONTENT

(71) Applicant: Sparrow Technology Inc., Okotoks (CA)

(72) Inventor: David Cramer, Okotoks (CA)

(73) Assignee: Sparrow Technology Inc., Okotoks (CA)

(21) Appl. No.: 16/713,944

(22) Filed: Dec. 13, 2019

Related U.S. Application Data
(60) Provisional application No. 62/780,042, filed on Dec. 14, 2018.

(51) Int. Cl. G06F 16/9536; H04L 29/08

(52) U.S. Cl. CPC G06F 16/9536; H04L 67/306

(57) ABSTRACT

A method for ranking the public disposition towards media articles on the internet that takes into account the system user's preferences for how to weight the opinions of members of the public (other users) who all have various objective attributes (geographic location or age for example) and also various objective parameters that are calculated based on their previous actions (thoughtfulness, integrity, frequency of interaction, etc. . . ).

### CROSS-REFERENCE TO RELATED APPLICATIONS

This application claims priority to U.S. Provisional Patent Application Ser. No. 62/780,042, filed Dec. 14, 2018 and entitled “System and Method for Quantifying Public Disposition with Respect to Electronic Media Content,” the entirety of which is incorporated by reference herein.

### BACKGROUND

An issue that requires attention today in the social media sphere is that it has become possible for a small number of people to abuse the structure of existing social media platforms to influence the opinion of a larger number of people than would be possible by using more traditional methods, like print media or face to face communication.

It is argued that the pace of technological change has thrust human beings into a situation where they are expected to absorb information and make decision in ways and at a pace that they are not evolved to handle.

It is a well-known and researched fact that humans lived in relatively small groups and tribes (100-250 people) up until about 7,000 years ago. It also fairly well agreed that human beings began using language to communicate as early as 100,000 to 200,000 years ago. Even taking the conservative number of 100,000 years ago, this means that at least 84% of human evolution with respect to our innate ability to understand, interpret, and judge information that reaches our brain through the communication channel of language occurred before people were living in groups larger than 250 people. This is important because the brain structures responsible for interpreting this information would have evolved the same way that other features of our physiology evolved in that a genetic mutation that results in a less fit method would result in a lower probability that one's genes would be propagated on to future generations. In the same way that poor eyesight would result in an organism receiving inferior information compared to its peers and therefore being less likely to reproduce, a relatively poor ability to filter information received through a verbal communication channel would result in a less fit individual with less chance of reproducing. Think of it in terms of gullibility—an individual who is easily fooled and believes anything that is said to it is unlikely to climb very high on the social ladder.

With the advent of the written word the system broke down further. Now it was possible for an individual to use language to communicate at a distance. He could write down some words and wouldn't have to take responsibility for them. The text could move around, and the content could enter the consciousness of another individual without the risk that it would affect the readers opinion of the writer. Individuals were still biased to believe information that came to their awareness through the language communication channel due to millennia of evolution, but writers no longer had to put much social capital at risk because they were largely communicating to individuals outside of their social circles. It is this phenomenon that makes propaganda possible.

Digital media has increased the magnitude of the problem because it has enabled anonymity and reduced to nothing the amount of social capital put at stake in order to gain influence.

### SUMMARY

Some embodiments present a system that helps individuals figure out which content they consume is trustworthy. In some embodiments, that system allows users specify which types of individuals' opinions they tend to trust. Some embodiments help establish a communication pattern that human minds are accustomed to working within to that incentivizes voluntary participation through the following attributes:
1. It rewards time spent within the system and interaction within the system with increased influence.
2. It rewards interaction and behavior that other users regard positively with increased influence.
3. It allows users to use their influence to shift public opinion (sometimes even subtly).
4. It allows users to adjust the criteria by which their algorithm determines material to be credible in a transparent way. That is, a user can prove to themselves that they are able to adjust parameters to make the algorithm work for them in a testable way.

### BRIEF DESCRIPTION OF THE DRAWINGS

For a detailed description of example embodiments, reference will now be made to the accompanying drawings in which:

FIG. 1 shows a block diagram of a system that provides a user interface executing on a client application which is in communication with a server executing a central evaluation program;

FIG. 2 shows a flowchart of a method performed by the system shown in FIG. 1;

FIG. 3 shows a voting interface according to some embodiments;

FIG. 4 shows a user preference dashboard according to some embodiments;

FIG. 5 shows a multi-user credibility scoring chart; and

FIG. 6 illustrates a detailed view of a computing device that can be used to implement the various components described herein, according to some embodiments.

### DEFINITIONS

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection is through a direct connection or through an indirect connection via other devices and connections.

### DETAILED DESCRIPTION

The following discussion is directed to various embodiments of the invention. Although one or more of these embodiments is preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

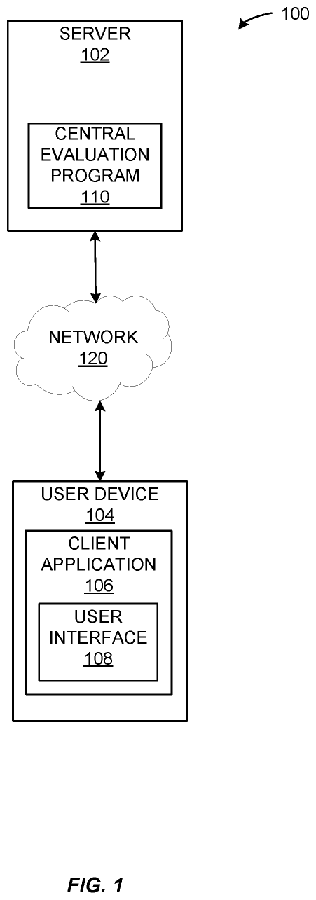

FIG. 1 is a block diagram of an example system 100. The system 100 provides a user interface 108 executing on a client application 106 in communication over a network 120 with a server 102 executing a central evaluation program 110 and two main databases (not pictured in FIG. 1). In some embodiments, the user interface 108 is an inconspicuous addition that runs on top of all of a user's social networking applications (such as the client application 106). In some embodiments, the user interface 104 is a part of a free-standing newsreader application. When a user consumes a piece of content in their social media applications (or the newsreader) the user will have the opportunity to interact with it through a credibility application. The central evaluation program 110 is an example of a cloud application/service hosted in a cloud services network.

Server 102 may include one or more server devices and/or other computing devices. User device 104 may be any type of stationary or mobile computing device, including a mobile computer or mobile computing device (e.g., a smart phone, a laptop computer, a notebook computer, a tablet computer such as an Apple iPad™, a netbook, etc.), a wearable computing device (e.g., a smart watch, a head-mounted device including smart glasses such as Google® Glass™, etc.), or a stationary computing device such as a desktop computer or PC (personal computer). One or more components of the system 100 may be communicatively connected via the network 120. The network 120 may include, for example, a local area network (LAN), a wide area network (WAN), a personal area network (PAN), and/or a combination of communication networks, such as the Internet.

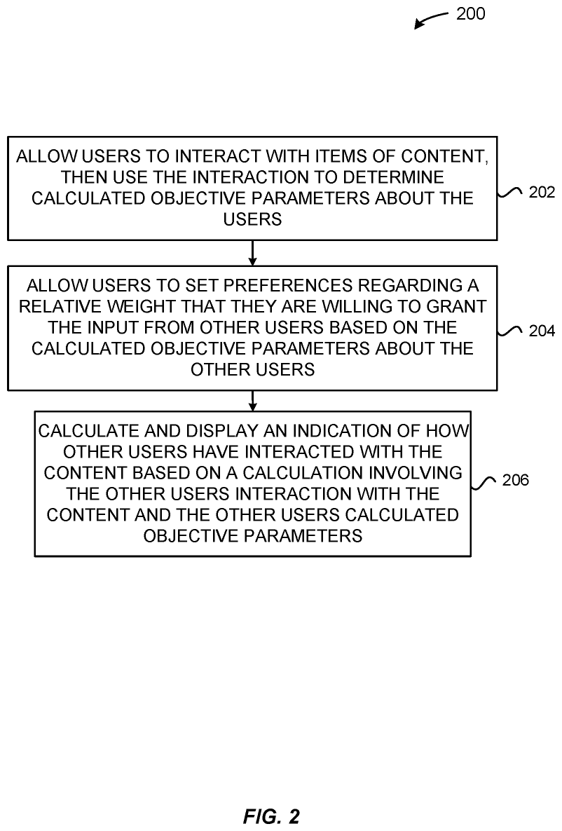

To help further describe the foregoing, FIG. 2 will now be described. FIG. 2 is a flowchart of a method 200 for calculating and displaying an indication of how other users have interacted with content. As shown in FIG. 200, the method of flowchart 200 begins at step 202. At step 202, users are allowed to interact with items of content and then the interaction is used to determine calculated objective parameters about the users. For example, with reference to FIG. 1, central evaluation program 110 allows users to interact with items of content and then uses the interaction to determine calculated objective parameters about the users.

At step 204, users are allowed to set preferences regarding the relative weight they are willing to grant the input from other users based on the calculated objective parameters about the other users. For example, with reference to FIG. 1, central evaluation program 110 allows users to set preferences regarding the relative weight they are willing to grant the input from other users based on the calculated objective parameters about the other users.

At step 206, an indication is calculated and displayed, where the indication represents how other users have interacted with the content based on a calculation involving the other users interaction with the content and the other users calculated objective parameters. For example, with reference to FIG. 1, central evaluation program 110 calculate and display an indication of how other users have interacted with the content based on a calculation involving the other users interaction with the content and the other users calculated objective parameters.

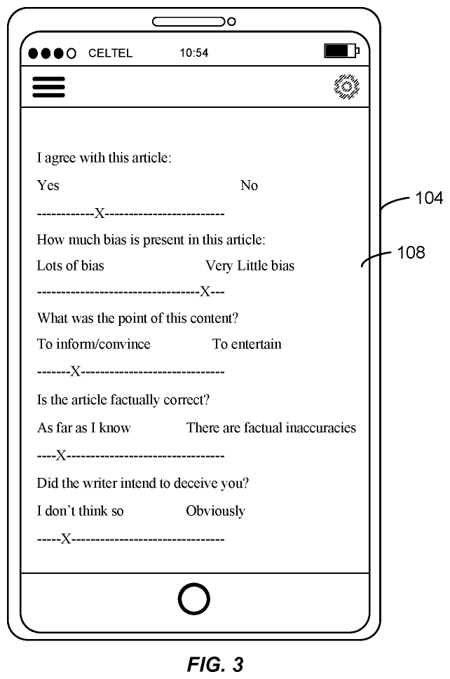

Additionally, as shown in FIG. 3, in accordance with some embodiments, the user interface 108 executing on the user device 104 enables a user to interact with content and thereby quantify subjective criteria by “voting” on quantifiable subjective criteria such as: how much a user agrees with the content; the amount of bias in content; the purpose of the content; how factually correct content is; and the intentions of the writer of the content.

Some embodiments present a more detailed questionnaire available for users who wish to be more specific about the nature of their feedback or possibly the option for a written response as well, which might be a way to help assess the fact that a user is an individual human being—copied responses might indicate a bot or at least a dishonest user who is passing off copied content as their own. In some embodiments, linguistic analysis algorithms rate other quantifiable aspects of implicit user response.

These votes are used and tallied to measure quantifiable traits of both the content and the user. Some embodiments generate a measure representation of the user's personal situation the user's integrity in reporting on content with which they interact. In ways that are described below, a measure of user honesty in reporting factual inaccuracies is determined in reference to the survey results from other users. This model does not require that there is an objective truth in any argument and instead relies on quantitative representations of the aggregated opinion of factual accuracy as a measure of truth or falsity. However, in some embodiments, the integrity of an individual user is something that is objectively quantified and is used to more highly weight the opinion of a user when measuring veracity.

In some embodiments, registered responses will go into two databases. For example, database 1 will give a unique ID to pieces of content that have been evaluated by a user. It will also record voting or surveys that have been collected by users who have interacted with the content. The survey responses are registered to the user who has logged the responses.

Database 2 will record users who are registered and their responses to items of content. Also, users in this database are assigned some parameters that are considered “objective”, which are determined by the central evaluation program (CEP). Objective Parameters include:
Several parameters on established personal disposition including but not limited to: Political right/left, religious orientation, openness, conservatism, disposition towards establishment, disposition towards particular issues (environment, etc. . . ). Based on track record agreeing or disagreeing with content.
Objectivity—Track record calling out dishonest content even when the article falls in line with personal disposition.
Honesty—Track record in NOT claiming something has been false that others with high objectivity scores have also deemed to be not false. Evidence of falsifying information about location, etc., (detected use of VPNs) can dramatically lower honesty score.
Integrity—Track record agreeing with articles that are displayed as potentially untrustworthy (indicates willingness to give up influence for the value of honesty). Also considered is consistency in actions over time. Will leave room for gradual changes in disposition but sudden swings will lower score until consistency is established.
Thoughtfulness—is based on considered opinions. May have to be calculated based on responses to written interactions.
Physical home location—detectable.
Time active on the site
Frequency of responses per day

In some embodiments, a basic record of how these scores change in time is stored so that others may “forgive” a transgression after a given amount of time. It is anticipated that the algorithms used to determine these scores and others like them is changed over time as more sophisticated AI can learn how to detect individuals “gaming the system”. Detected gaming would dramatically lower Honesty and/or Integrity scores. The degree to which how much the scores would be lowered in those cases could be based on psychological testing that put the algorithms actions in concert with how a human being would tend to behave.

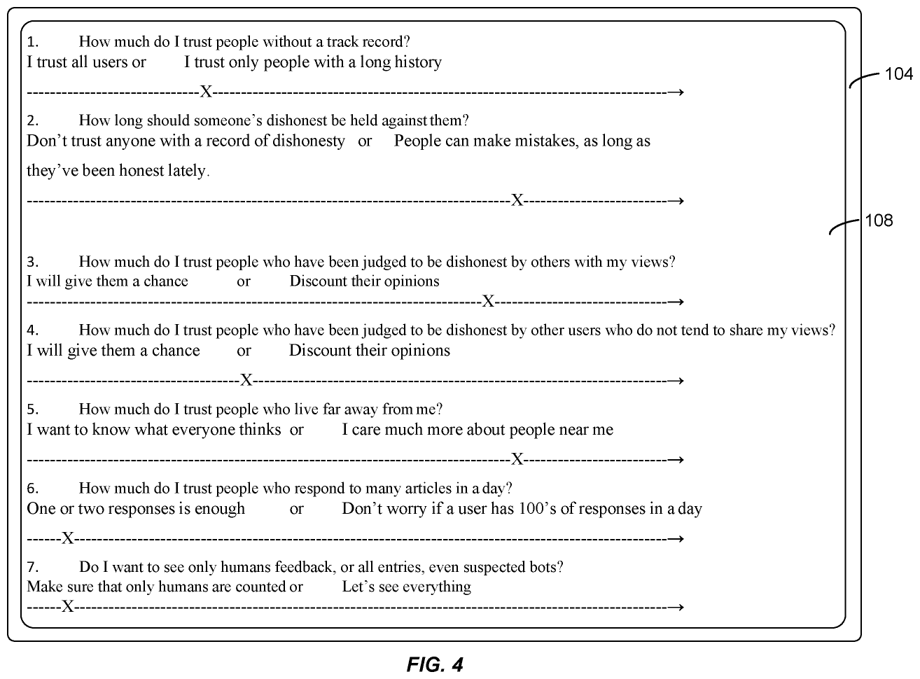

The user application also has a set of user adjustable parameters that inform the operating algorithm how much to weigh the opinion of any other member of the user pool. While an algorithm that determines these values based on some sort of psychological questionnaire could be constructed, a basic version of this dashboard is depicted in FIG. 4, where the dashboard is displayed the user interface 108 on the user device 104.

Other types of questions are supported in some embodiments. For example, in some embodiments, individuals will not be able to judge or rank the trustworthiness of other individuals directly. A user may judge the trustworthiness or intention of submitted content or behavior (an objective event), which the database would keep track of and would reflect on the content being judged and would also be used to calculate objective attributes about that user, to the extent that other users have already interacted with that content.

In some embodiments, there is strong incentive to stay within the system and not to abandon an account and start a new one, which is accomplished optimization of the algorithm for one's influence to be very low at the outset of the formation of an account and to build as time progresses.

In some embodiments, there is not one universal “credibility score” attached to any content. In some embodiments, the “credibility score” is as individual as each user, although individuals with similar dispositions who set up their personal preferences in a similar way observe articles with similar credibility scores.

In some embodiments, there is not a specific “credibility score” attached to any individual. In some embodiments, how much credibility one individual gives to another is based on personal experience and values, which is reflected in personal parameters that are selectable.

In chronological order, the software system behaves as follows:

Some embodiments include a database of users having responded to multiple pieces of content in the past and having an established set of Objective Parameters associated with their unique ID.

When someone somewhere creates a piece of content and posts it to social media somewhere, if the poster is a registered user of the software, then the content carries metadata associated with it, but if not then at some point a user interacts with the content by filling out the simple survey card (Do you agree, is it factual, etc . . . as above). At the point that a survey card is submitted attached to a piece of content that is not yet logged in the database a new entry is made for it. The returned survey along with the Objective parameters of the user that was associated with the survey is logged, creating a set of “votes” along with the objective parameters of everyone who voted.

As one or more surveys are completed, a credibility score is created for each article that is specific to the individual that is consuming it (but who hasn't yet necessarily voted on it), based on their explicit instructions about what type of attributes to trust in other individuals.

As the article becomes voted on or interacted with to some degree a credibility score can show up unobtrusively on a tool bar or in some other area of the users' monitor that indicates that it is relevant to the article or content. The way that this works is that as content is displayed on a users' monitor (because of sharing or because of the activity of some other algorithm within the base social media application being used) a notification is sent to the Database 1 (the content database) along with the users' personal preferences and a credibility score is then be calculated using the users' preferences along with all of the votes that have been previously cast with respect to that content that information about the each of the voters.

As an example that just takes into account physical location, let's suppose that there is a piece of content that is very well agreed with by people in my home town but disagreed with more largely throughout the nation. If I have set my “Do I trust people near me?” slider to the far left, where I only care what people near me have to say then that article might get a credibility score of, say, 85% when I look at it. However, maybe my neighbor is more open minded, and he has his slider set the other way, where he explicitly values the opinions of a much larger area the credibility score that that same article will show on his monitor might only be 50%. In this way we avoid assigning a definitive credibility to any particular piece of content and let the algorithm help a user use their own values to define whether or not a piece of content is credible.

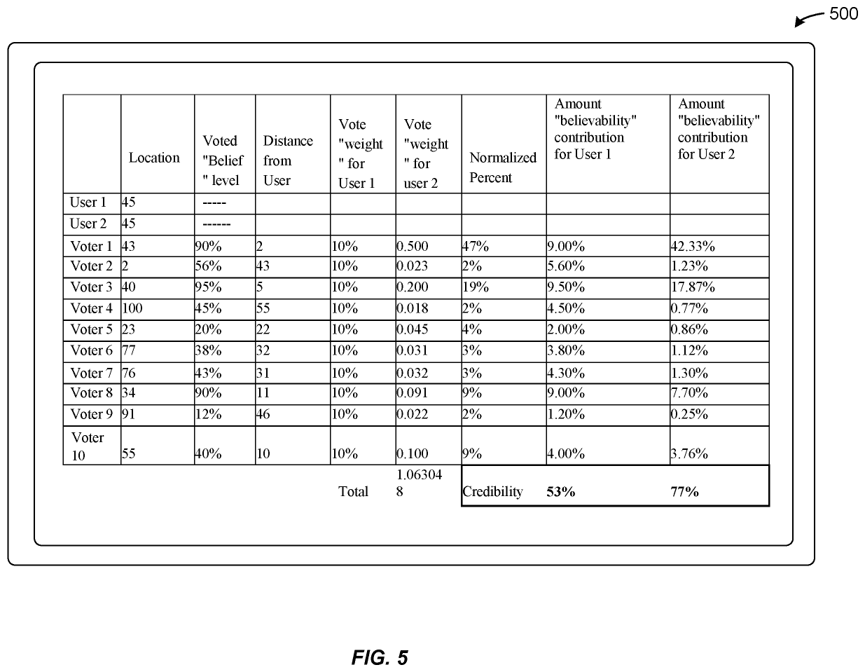

Consider physical location as a point on a line and assume that both user 1 and user 2 occupy a location that is at “Number 45” on that line. The rest of the population who have voted on the article occupy locations along the line between 0 and 100, with locations like 0 and 100 being as far away as one can get from location 45 in either direction. If 1 one has specified that it doesn't matter where the voters or respondents are located, then all of their votes is taken equally in order to provide him with an indication of how the opinions that matter to him feel about the credibility of the content. User 2 who specifies that he wants to weight the relative value of individuals who live closer to him higher than those who live farther away will have a weighting algorithm applied to each user's vote depending on their location. The results is normalized and tallied and then a credibility score that is specific to his preferences is displayed, as shown in FIG. 5.

This is very simple example using one preference variable and a linear weighting algorithm. In some embodiments, the application uses several variables and more complex weighting schemes, making a multi-dimensional calculation.

In some embodiments, a credibility score is calculated based on the input of other users. In some embodiments, a user may choose to interact with the content himself, casting votes into the software system. When this happens, that survey is sent to Database 2 (the User database) along with the aggregate universal data about that piece of content at the time so that the contribution of this newest vote to the users' objective parameters is calculated. While an algorithm uses the user's preferences to judge the credibility of a piece of content, the user's objective parameters are calculated based on his interaction with the article relative to a much larger section of the population than the subset that he/she has singled out in his/her preferences. The reason for this is that while we get to choose who we trust, we don't get to pick the criteria by which we are judged by others.

In some embodiments, this work is done with the use of only one database or in a scenario where the responsibility for each of the functions was held in a different location, but this demonstrates how the job might easily be accomplished.

Moreover, the embodiments described herein enable a user to view or consume online content with an easily readable indication of how credible (in terms of bias, trustworthiness, and intention) he or she would find it if he or she had access to all of the interactions of the people who had rated or interacted with the content and could form an opinion about the credibility of each and every one of those people based on their online behavior.

The basic premise of the system is that there are two main aspects that determine how much credibility an individual would give another second party, should that first individual have a complete knowledge of the second individual's history of interpersonal interactions. The first aspect are objective measures such as honesty, thoughtfulness, and integrity. The second aspect is generally how similar that second individual is to the first one in terms of values and perspective, which we will call social proximity. The social proximity of one person to another is relative to the perspective from which the calculation is done. For example, the social proximity of person X to person Y is not necessarily the same as the social proximity of person Y to person X.

In the described system, attributes like honesty and thoughtfulness are inferred from interactions and how they compare with the reviews and interactions of other users. The relative similarity of one individual to another, or social proximity, is more complicated but can be determined on a variety of axes. There are potentially an infinite number of scales or axes on across which individuals can be compared so an important aspect of the system is limiting the analysis to axes that are important to an individual user.

As an example, suppose that it is determined that a population of individuals have six axes of comparison upon which the relevance rises above a certain threshold. These axes may be social issues such as stance on gun control, national security, immigration, climate change, tax rate, and opinion on size of government. There may be other axes that have less importance for the overall group and they need not be considered if their aggregate relevance falls below a threshold. These axes can be determined by an analysis of the interaction of all of the individuals in the population with respect to media content shared in the system.

Suppose that one individual in the population (individual X) cares very much about social issues A, B, and C but very little about other issues whereas another individual (call him individual Y) may have strong feelings about issues E and F but little else. This means that the criteria that individual X would use to determine who is similar to him will be different than the criteria that individual Y would use. The “social proximity” of a random third individual (individual Z) to individual X would be the product of the differences between positions of individual X and individual Z on the A, B, and C axes. The “social proximity” of individual Z to individual Y would be the product of the differences between positions of individual Y and individual Z on the E and F axes. In another embodiment the proximity is calculated as the vector sum of the proximity on individual axes.

The software system must use a similar method of determining similarity so as to seem genuine to a user and while there are a potentially infinite number of relational axes, a truncated list of the most important two to five axes for each individual can generally be used. The particular list of axes that each individual considers important when determining if another tends to share their values can be entered explicitly or can be inferred from the tendency of an individual to interact with articles that have that value as a primary concern.

Axes do not need to be labeled or even chosen manually. Rather, a group of articles can be selected that have a strongly intersecting group of individuals who interact with them. For instance, the individuals who tend to agree with article A are the same group who agree with article B, and C, and D. Instances of a strong correlation can be chosen as axes and then extrapolated by searching the database for content that the individuals involved in the initial axes selection interacted with that is also content that the user has interacted with.

For a software system to work as described there is a database or series of databases with at least three tables. The tables contain the following information. First, the Articles Table is a list of every piece of content or media that is shared through the application. Any article that is included on the table will also have its web location referenced. Articles that are shared or otherwise referenced inside the application that do not have an entry on the articles table will be given an entry as soon as any user reviews or shares them through the software system. Items in the Articles Table include:
Unique ID
Web Location
Number of Reviews
Primary Social Axis
Primary Social Axis Position
Secondary Social Axis
Secondary Social Axis Position

The definitions for the above entries include:
Unique ID—Database identifier number. Self Generated
Web Location—Unique URL for each piece of content. Used to prevent duplicate entries.
Number of Reviews—Total number of interactions with respect to the article. Updated every time a user makes an interaction with the article.
Primary Social Axis—either labeled or numbered representation of the identified social axis that divides public opinion that is most strongly identified with the article. For example, if the article pertains to the issue of Climate change then the Primary Social Axis will likely be “Climate Change”.
Primary Social Axis Position—a numerical value that represents the aggregate of the opinions of the reviewers of the article.
Secondary Social Axis—similar to the Primary Social Axis but allows for a secondary issue to be part of the analysis. For example, even though the article may primarily deal with climate change there may be an element of the article that pertains to the spending of tax dollars so the Secondary axis may be “Tax Spending” or something similar.
Secondary Social Axis Position—a numerical value that represents the aggregate of the opinions of the reviewers of the article with respect to the Secondary Social Axis.

A second table includes a Members Table that is a list of every unique individual who uses the application. The attributes stored in this table are as follows:
MemberlD
Home Location
Gender
Age
Starting Date
Honesty
Thoughtfulness
Integrity
Importance of Honesty
Importance of Thoughtfulness
Importance of Integrity
Similarity Preference
First Social Axis
First Social Axis Position
Second Social Axis
Second Social Axis Position

The corresponding definitions for the entries includes:
Member ID—Database identifier number which is self-generated
Home Location—Identification for the geographical location of the user.
Gender—gender of the user. Used to determine similarity with other users.
Age—Age of user.
Starting Date—date that the user started using the platform. Users with longer time on the platform generally have more credibility.
Honesty—a calculated number that takes into account the user's interactions on the platform. A stated position on an article that is contrary to other indications from a user's interactions for the purpose of gaining influence would decrease honesty rating.
Thoughtfulness—a calculated number that takes into account the user's interactions on the platform. Interactions that contain an amount of well written text will be seen as more thoughtful than interactions that do not.
Integrity—a calculated number that takes into account the user's interactions on the platform. The tendency of the member to review the bias, intention, and truthfulness of articles in a way that does not correlate with his or her personal opinion will increase Integrity rating.
Importance of Honesty—a user entered number that represents the increase in weight that the user would give to interactions, comments, and reviews that come from other users with a higher honesty score.
Importance of Thoughtfulness—a user entered number that represents the increase in weight that the user would give to interactions, comments, and reviews that come from other users with a higher thoughtfulness score.
Importance of Integrity—a user entered number that represents the increase in weight that the user would give to interactions, comments, and reviews that come from other users with a higher integrity score.
Similarity Preference—a user entered number that represents the increase in weight that the user would give to interactions, comments, and reviews that come from other users a higher social proximity.
First Social Axis—the social issue that is of primary importance to the member. This can be user selected or determined from interactions.
First Social Axis Position—a numerical value that represents the position of the member on the social axis that is of primary importance to him or her.
Second Social Axis—the social issue that is of secondary importance to the member. This can be user selected or determined from interactions.
Secondary Social Axis Position—a numerical value that represents the position of the member on the social axis that is of secondary importance to him or her.

Interactions table is the third table in the database is the interactions table. This table keeps track of every rating, review, or comment of a piece of media or “article” that is captured as part of the database. The following items are in the Interactions Table:
Unique ID
Article Unique ID
Member ID
Interaction Time and Date
Bias Rating
Trustworthiness Rating
Intention Rating
Agreement Rating

The definitions for the Entries includes:
Unique ID—Database identifier number. Self-Generated
Article Unique ID—Identification for the article being referenced.
Member ID—Identification for the user making the interaction
Time and Date—Time and date of the comment or interaction.
Bias Rating—An entered value that represents the reviewing member's judgement of how biased the article is in its representation of the facts.
Trustworthiness Rating—irrespective of the bias rating, this is an entered value that represents the reviewing member's judgement of how accurate or trustworthy the information in the article is.
Intention Rating—An entered value that represents the reviewing member's judgement of the intention of the author of the article. The two sides of this scale are “To inform” and “To deceive”, with “To influence” being in between those sides.
Agreement Rating—an entered value that reflects how well the position of the article aligns with the users own values.

A new line in this table is created whenever any member interacts with any article. This table can be sorted by member or by article so that all of the interactions on record by a particular member or pertaining to any particular article can be easily accessed.

In the operation of the system there are several things that a user can elect to do with the software. Each of these actions initiates some steps taken by the software and ends in a result. The result may be either a change to the database or some output for the user.

When a user signs up as a new user to the system, the software prompts the user to fill out a form detailing some basic information and personal preferences. The software enters the information in the Members Table of the database and the user is assigned a password that allows him or her to access the software. The result is that the Members table now contains a new entry for a user of the system. The honesty, thoughtfulness, and integrity values for a new member are set at a default neutral level since there are no interactions by which the software can infer these ratings. Primary and Secondary social axis information may be included form the form or it may be left at a default neutral level until the software can determine a rating based on interactions with content.

When a user reviews a piece of online content, the software checks to see if there is an existing record for the article or content. If not then the software creates a new record for it in the Articles Table, with the unique web location serving as the definitive reference for the piece of content.

If there already is a record for the article then the user fills out a short form that allows him to rate the article for accuracy, intention, and for how much the user agrees with the perspective of the article.

Information from the above form is entered in the interactions table, along with the user ID and the unique ID of the article.

The interactions table is sorted for all interactions related to the relevant article and then information for the contributing member for each interaction is retrieved. Using the retrieved information the primary and secondary social axis for the article are determined as well as the location for the article on each of those axes.

The information for the user who is making the review is updated based on his or her interactions with respect to the article. The users' position on social axes is updated based on the interaction. The user's honesty, thoughtfulness, and integrity numbers are updated based on the interaction as well. The less correlated a users' reviews of the articles bias and trustworthiness are with his or her personal views, the higher his or her integrity rating. The better written text that a user offers as a comment, the higher his or her thoughtfulness rating. Honesty rating gradually builds but can be quickly decreased with evidence that a user is not based where claimed to be or that there is a calculated campaign by the user to spread disinformation.

The result is that the Interaction table now has a new entry. Also the line in the Articles table that pertains to the relevant article has been updated to reflect the new information that has been added to the information available on the article because of the new interaction. The line in the Members table that pertains to the member reviewing the article has been updated to reflect new information calculated or inferred as a result of the members interaction with the relevant article.

When a user views an article or piece of content online, the software sorts the Interactions table for all interactions pertaining to the relevant article. The software then accesses the Members table for information about the member who made each interaction. The social proximity for each reviewing member with respect to the viewing member is calculated.

The software calculates an aggregate number for bias, trustworthiness, and intention of the article that is specific to the viewing user. The user who is viewing the article will prefer how much importance to give the honesty and integrity of other contributing members. Each interaction for the relevant article is now weighted with respect to the social proximity of the reviewer to the viewing user and with respect to the honesty and integrity rating of the reviewer. The aggregate numbers for bias, trustworthiness, and intention are displayed somewhere obviously visible on the article.

The result is that the user can view or consume the content with an easily readable indication of how credible (in terms of bias, trustworthiness, and intention) he or she would find it if he or she had access to all of the interactions of the people who had rated the article and could form an opinion about the credibility of each and every one of those people based on their online behavior.

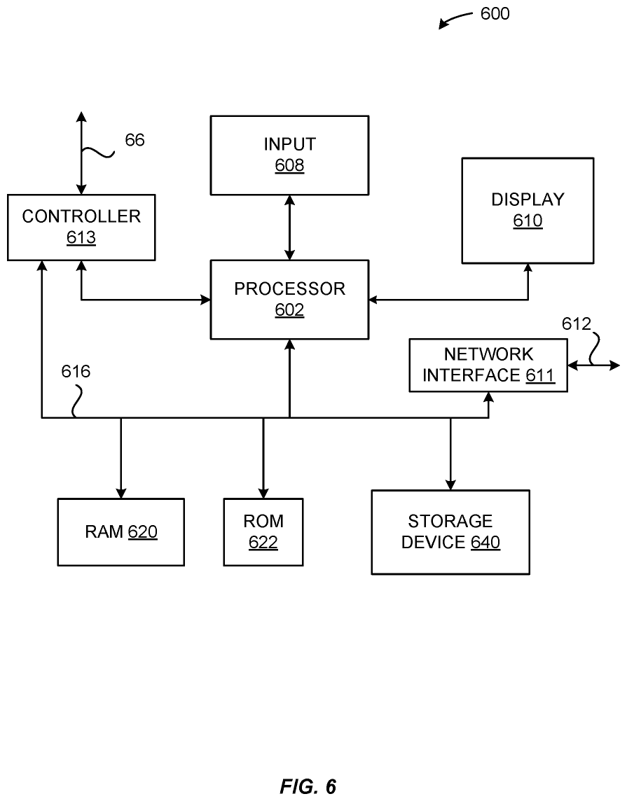

FIG. 6 illustrates a detailed view of a computing device 600 that can be used to implement the various components described herein, according to some embodiments. In particular, the detailed view illustrates various components that can be included in the server 102 and the user device 102 illustrated in FIG. 1. As shown in FIG. 6, the computing device 600 can include a processor 602 that represents a microprocessor or controller for controlling the overall operation of the computing device 600. The computing device 600 can also include a user input device 608 that allows a user of the computing device 600 to interact with the computing device 600. For example, the user input device 608 can take a variety of forms, such as a button, keypad, dial, touch screen, audio input interface, visual/image capture input interface, input in the form of sensor data, and so on. Still further, the computing device 600 can include a display 610 that can be controlled by the processor 602 to display information to the user. A data bus 616 can facilitate data transfer between at least a storage device 640, the processor 602, and a controller 613. The controller 613 can be used to interface with and control different equipment through an equipment control bus 66. The computing device 600 can also include a network/bus interface 611 that couples to a data link 612. In the case of a wireless connection, the network/bus interface 611 can include a wireless transceiver.

As noted above, the computing device 600 also includes the storage device 640, which can comprise a single disk or a collection of disks (e.g., hard drives), and includes a storage management module that manages one or more partitions within the storage device 640. In some embodiments, storage device 640 can include flash memory, semiconductor (solid-state) memory or the like. The computing device 600 can also include a Random-Access Memory (RAM) 620 and a Read-Only Memory (ROM) 622. The ROM 622 can store programs, utilities or processes to be executed in a non-volatile manner. The RAM 620 can provide volatile data storage, and stores instructions related to the operation of processes and applications executing on the computing device.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, hard disk drives, solid-state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present invention. Numerous variations and modifications become apparent to those skilled in the art once the above disclosure is fully appreciated. It is intended that the following claims be interpreted to embrace all such variations and modifications.

What is claimed is:

1. A system, comprising:
a server;
one or more databases; and
a computer program product in a computer readable medium configured to cause the server to
allow users to interact with items of content, then use the interaction to determine calculated objective parameters about the users,
allow users to set preferences regarding a relative weight that they are willing to grant the input from other users based on the calculated objective parameters about the other users, and
calculate and display an indication of how other users have interacted with the content based on a calculation involving the other users interaction with the content and the other users calculated objective parameters.

2. The system of claim 1, wherein the computer program product causes the server to calculate a probability that one of the users is a real person and not a bot algorithm.

3. The system of claim 1, wherein the computer program product causes the server to calculate an objectivity of one of the users as a calculated objective parameter.

4. The system of claim 1, wherein the computer program product causes the server to calculate an integrity of one of the users as a calculated objective parameter.

5. The system of claim 1, wherein the computer program product causes the server to calculate an honesty of one of the users as a calculated objective parameter.

6. The system of claim 1, wherein the computer program product causes the server to calculate a personal disposition towards certain types of content of one of the users as a calculated objective parameter.

7. A system, comprising:
a server;
one or more databases; and
a computer program product in a computer readable medium configured to cause the server to
allow users to interact with items of content, then use the interaction to determine a measure of social value disposition about the users, and
calculate and display an aggregate indication of how other users have interacted with the content based on a calculation involving the other users interaction with the content and the other users calculated measure of social value disposition with respect to a user who is viewing the content.

8. The system of claim 7, wherein the one or more databases are separated into three tables

9. The system of claim 8, wherein one of the three tables maintains a list of all of the users of a software.

10. The system of claim 8, wherein another of the three tables maintains a list of all of the items of content that have corresponding interactions.

11. The system of claim 8, wherein another of the three tables maintains a list of all of the interactions that have taken place by all of the users regarding any of the content.

12. A system, comprising:
a server;
one or more databases; and
a computer program product in a computer readable medium configured to cause the server to
allow users to interact with aspects of content, then use the interaction to determine calculated objective parameters about the users,
allow users to set preferences regarding a relative weight of feedback that they are willing to accept from other users based on the calculated objective parameters, and
calculate and display an indication of how other users have interacted with the content based on a calculation involving the other users interaction with the content and the other users calculated objective parameters.

13. The system of claim 12, wherein the computer program product causes the server to calculate a position of a first user on at least one axis of social value disposition.

14. The system of claim 13, wherein the computer program product causes the server to calculate the position of the other users on the at least one axis of social value disposition.

15. The system of claim 14, wherein the computer program product causes the server to weigh the input from the other users inversely proportionally to a distance from the first user on the at least one axis of social value disposition.

16. The system of claim 15, wherein there are several axes of social value dispositions.

17. A method, comprising:
allowing users to interact with aspects of content, then uses the interaction to determine calculated objective parameters about the users;
allowing users to set preferences regarding a relative weight of feedback that they are willing to accept from other users based on the calculated objective parameters; and
calculating and displaying an indication of how other users have interacted with the content based on a calculation involving the other users interaction with the content and the other users calculated objective parameters.

18. The method of claim 17, further comprising calculating a probability that one of the users is a real person and not a bot algorithm.

19. The method of claim 17, further comprising calculating an objectivity of one of the users as a calculated objective parameter.

20. The method of claim 17, further comprising calculating an integrity of one of the users as a calculated objective parameter.

21. The method of claim 17, further comprising calculating an honesty of one of the users as a calculated objective parameter.

22. The method of claim 17, further comprising calculating a personal disposition towards certain types of content of one of the users as a calculated objective parameter.
